(19) United States
(12) Patent Application Publication
(10) Pub. No.: US 2006/0113827 A1
(43) Pub. Date: Jun. 1, 2006

(54) Seat for a vehicle

(75) Inventors: Arne Stoschek, Palo Alto, CA (US); Cedric Dupont, Sunnyvale, CA (US); Daniel Rosario, Santa Cruz, CA (US)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: Volkswagen AG

(21) Appl. No.: 11/186,460

(22) Filed: Jul. 21, 2005

Related U.S. Application Data
(60) Provisional application No. 60/590,244, filed on Jul. 22, 2004.

(51) Int. Cl. A47C 7/62; H01J 1/62

(52) U.S. Cl. 297/188.01; 313/483

(57) ABSTRACT

A seat for a vehicle comprises a seat surface and a monitor arranged on a side of the seat facing away from the seat surface for display of freely variable pictures or symbols, in which the monitor contains an emission layer, containing a light-emitting polymer, and a transparent carrier layer, made of a flexible material.

### CROSS-REFERENCE TO RELATED APPLICATION

This application claims priority to U.S. Provisional Patent Application No. 60/590,244, which was filed on Jul. 22, 2004, and is incorporated herein by reference in its entirety.

### TECHNICAL FIELD

The invention concerns the use of a monitor to display freely variable pictures or symbols, i.e., for flexible depiction of displays or depiction of films or film sequences, in a vehicle, especially a motor vehicle.

### SUMMARY

The task of the invention is to increase customer acceptance of monitors in vehicles, especially motor vehicles.

The aforementioned task is solved by a seat for a vehicle, especially for a motor vehicle, with a seat surface and a monitor arranged on a side of the seat facing away from the seat surface for depiction of freely variable pictures or symbols, in which the monitor includes an emission layer, containing a light-emitting polymer, and a transparent carrier layer made of a flexible material, consisting essentially of flexible plastic, and in which the emission layer, in one embodiment of the invention, is arranged beneath the transparent carrier layer from a viewing direction of the monitor. The monitor, in another embodiment of the invention, is mounted on a soft material, especially on a soft material with a thickness of at least about 2 cm.

In another embodiment of the invention, the emission layer comprises a first light-emitting polymer for emission of light of a first color and a second light-emitting polymer for emission of light of a second color, in which the first light-emitting polymer, in a further embodiment of the invention, is arranged next to the second light-emitting polymer.

In another embodiment of the invention, the emission layer comprises a first light-emitting polymer for emission of light of a first color, a second light-emitting polymer for emission of light of a second color and a third light-emitting color for emission of light of a third color, in which, in a further embodiment of the invention, the first light-emitting polymer, the second light-emitting polymer and the third light-emitting polymer are arranged next to each other.

In another embodiment of the invention, the light-emitting polymer includes a spiro compound, for example, a spiro compound according to the formula 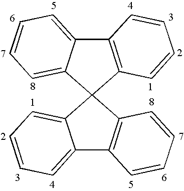
Details of such spiro compounds can be taken from EP 0 676 461 B1 (incorporated by reference) or U.S. Pat. No. 5,840,217 (incorporated by reference).

In an alternative embodiment of the invention, the light-emitting polymer includes polyphenylenevinylenes (PPV), for example, R-PPV, for example, 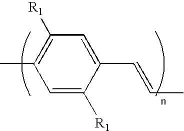
Or CN-PPV, for example, 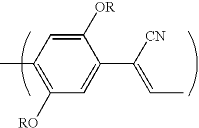
Or polyfluorenes. Methods for dissolution of polymers for subsequent printing (for example, on the transparent carrier or on an electrode arranged on the transparent carrier) can be taken, for example, from WO 03/019694 A2 (incorporated by reference) or DE 101 41 624 A1 (incorporated by reference).

In another embodiment of the invention, the monitor includes a number of linear or strip-like front electrodes arranged between the emission layer and the transparent carrier layer.

In another embodiment of the invention, the monitor includes a number of linear or strip-like rear electrodes arranged on a side of the emission layer facing away from the transparent carrier layer.

In another embodiment of the invention, the monitor includes a number of linear or strip-like front electrodes, running essentially parallel to each other, arranged between the emission layer and the transparent carrier layer, and a number of linear or strip-like rear electrodes, running parallel to each other, arranged on a side of the emission layer facing away from the transparent carrier layer, in which the front electrodes are arranged not parallel, but essentially at right angles to the rear electrodes.

In another embodiment of the invention, the emission layer is a layer applied by means of an inkjet process.

The aforementioned task is also solved by a steering wheel for a vehicle with a monitor for depiction of freely variable pictures or symbols, comprising a monitor arranged on a side facing the user, and especially including the aforementioned features of the monitor arranged on the seat, in which the monitor includes an emission layer, containing a light-emitting polymer, and a transparent carrier layer, made of a flexible material.

The aforementioned task is also solved by a vehicle with a monitor to depict freely variable pictures or symbols, comprising, in particular, the aforementioned features of the monitor arranged on the seat, in which the monitor includes an emission layer, containing a light-emitting polymer, and a transparent carrier layer, made of a flexible material.

The vehicle according to the invention is especially a land vehicle, usable individually in traffic. Motor vehicles according to the invention are not particularly restricted to land vehicles with an internal combustion engine.

Additional advantages and details are apparent from the following description of practical examples.

### BRIEF DESCRIPTION OF THE DRAWINGS

FIG. 1 shows a practical example of a seat of a vehicle;

FIG. 2 shows a three-dimensional sketch of a monitor;

FIG. 3 shows a top view of a practical example of an emission layer;

FIG. 4 shows a practical example of an internal view of a vehicle.

### DETAILED DESCRIPTION

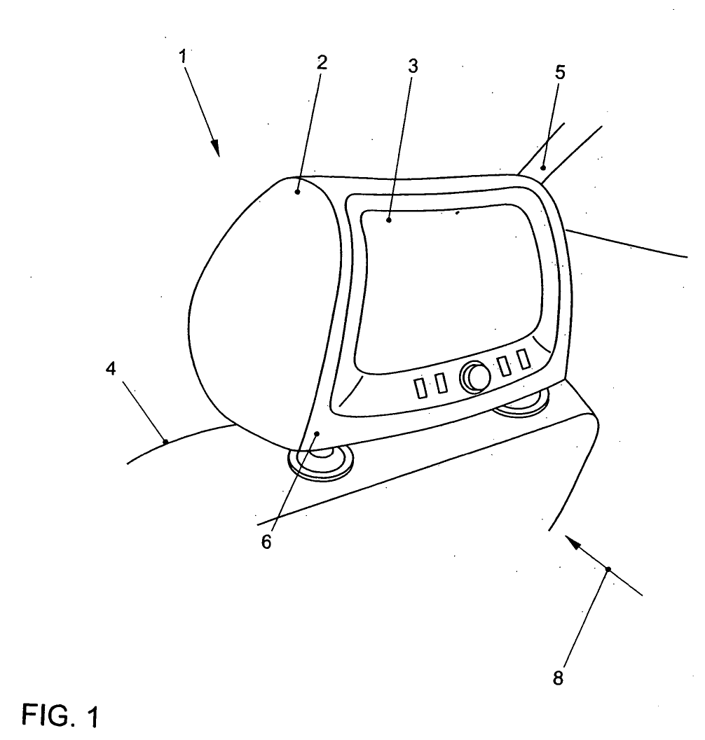

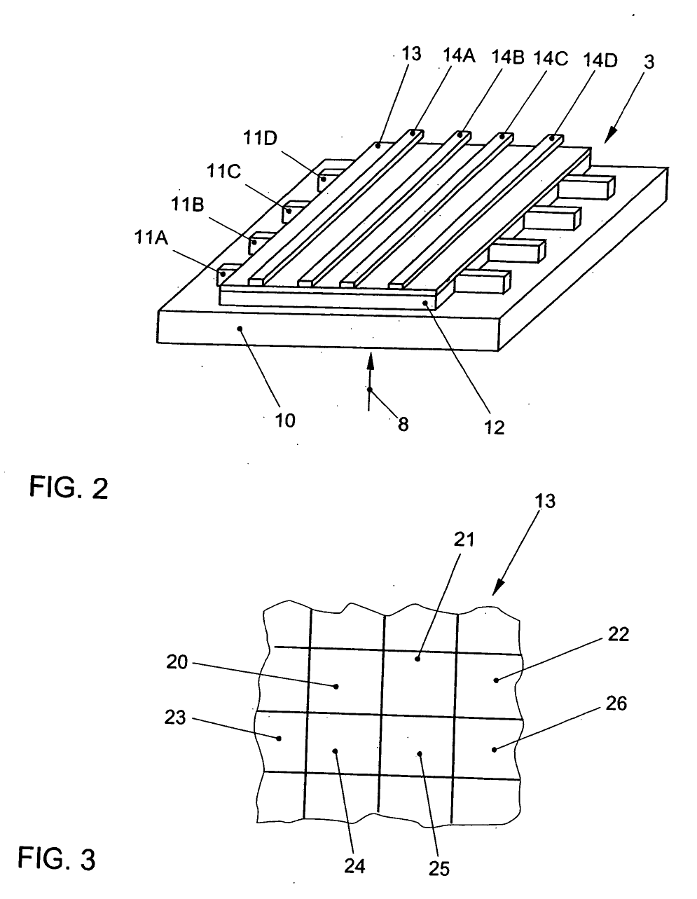

FIG. 1 shows a practical example of a seat 1 of a vehicle 5. Seat 1 includes, in one embodiment, a head support 2, which is lined with a soft material, like foam. Reference number 4 denotes a seat surface of seat 1. A monitor 3, to depict freely variable pictures or symbols, is arranged on a side 6 of seat 1 or head support 2 facing away from seat surface 4, in which an arrow, denoted with reference number 8 in FIG. 1 and FIG. 2, shows the viewing direction of a viewer of monitor 3. Freely variable pictures or symbols according to the invention can be, for example, films, especially cartoons. Freely variable pictures or symbols according to the invention can be displayed concerning the vehicle, which, however, are not stipulated by the monitor, but can be generated by a control (not shown) to drive monitor 3. However, the invention is particularly suitable for depiction of cartoons.

FIG. 2 shows a three-dimensional sketch of monitor 3. Monitor 3 contains a transparent carrier layer 10, consisting essentially of a flexible material, especially essentially from flexible plastic. With reference to the viewing direction, transparent linear or strip-like front electrodes 11A, 11B, 11C, 11D, for example, from ITO (indium tin oxide), are arranged beneath the transparent carrier layer 10. With reference to the viewing direction, a conducting polymer layer 12, for example, from PANI, PDOT or PSS, is arranged beneath the transparent linear strip-like front electrodes 11A, 11B, 11C, 11D, as well as between the transparent linear or strip-like front electrodes 11A, 11B, 11C, 11D. With reference to the viewing direction, an emission layer 13, containing at least one light-emitting polymer, is arranged beneath the conducting polymer layer 12 and above the linear or strip-like rear electrodes 14A, 14B, 14C, 14D. The linear or strip-like front electrodes 11A, 11B, 11C, 11D and the linear or strip-like rear electrodes 14A, 14B, 14C, 14D each run essentially parallel to each other, but the linear or strip-like front electrodes 11A, 11B, 11C, 11D are arranged essentially at right angles to the linear or strip-like rear electrodes 14A, 14B, 14C, 14D.

The structure depicted in FIG. 2 is only an example. A different arrangement of the layers, configured by analogy to U.S. Pat. No. 6,605,483 (incorporated by reference) can also be prescribed.

Spiro compounds, for example, a spiro compound according to the formula 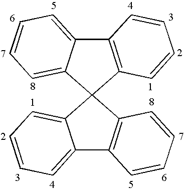 can be used as a component of the emission layer 13, containing at least one light-emitting polymer. Details concerning such spiro compounds can be taken from EP 0 676 461 B1 (incorporated by reference) or U.S. Pat. No. 5,840,217 (incorporated by reference). Additional details on spiro compounds can be taken from the Internet site www.covion.com/technology/tech_summary.html (incorporated by reference).

In an alternative or additional embodiment, the emission layer 13, containing at least one light-emitting polymer, includes polyphenylenevinylenes (PPV), for example, R-PPV, for example, 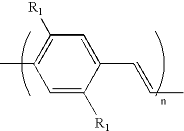
Or CN-PPV, for example,

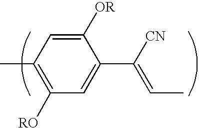

Or polyfluorenes. A method for dissolution of polymers for subsequent printing can be taken, for example, from WO/03019694 A2 (incorporated by reference) or DE 101 41 624 A1 (incorporated by reference), as well as the aforementioned Internet site www.covion.com/technology/tech_summary.html.

It is prescribed that the emission layer 13, as shown in sections in FIG. 3, is divided into segments, 20, 21, 22, 23, 24, 25, 26, in which segments 20, 21, 22, 23, 24, 25, 26 are configured, so that at least two different, but especially three different colors can be emitted. For example, it can be prescribed that the light-emitting polymer of segments 20, 23 and 26 is Covion PolySpiroRed CR01, that the light-emitting polymer of segments 21 and 24 is Covion PolySpiroBlue, and that the light-emitting polymer of segments 22 and 25 is PDY 132 (Covion Yellow). Segments 20, 21, 22, 23, 24, 25, 26 are especially arranged, so that their center point is arranged essentially on an intersection site of a linear or strip-like front electrode 11A, 11B, 11C, 11D and a linear or strip-like rear electrode 14A, 14B, 14C, 14D.

In an alternative to the segments 20, 21, 22, 23, 24, 25, 26 depicted in FIG. 3, the emission layer 13 can be divided into strips. For example, one such strip can replace segments 20, 21, 22 and another strip can replace segments 23, 24, 25, 26. It can be prescribed, for example, that the light-emitting polymer of the strip replacing segments 20, 21, 22 is Covion PolySpiroRed CR01, that the light-emitting polymer of the strip replacing segments 23, 24, 25, 26 is Covion PolySpiroBlue CB02, and that the light-emitting polymer of an additional strip is PDY 132 (Covion Yellow).

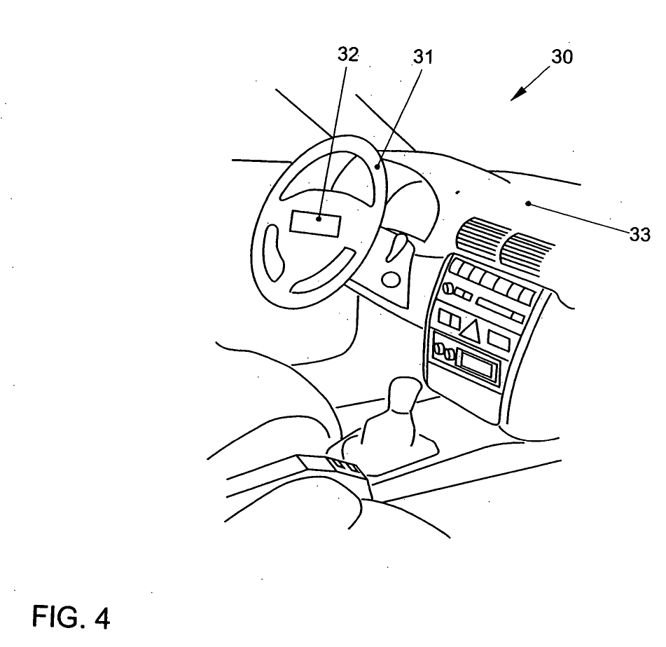

FIG. 4 shows a practical example of an internal view of a vehicle 30 with a steering wheel 31, designated with reference number 31. The steering wheel 31 has a monitor 32, configured according to monitor 3, for depiction of freely variable pictures or symbols. The monitor 32 is applied to a soft material, especially a soft material with a thickness of at least about 2 cm. As an alternative or in addition, a monitor corresponding to monitor 32 can also be arranged on a dashboard 33.

The invention increases the subjective feeling of safety of passengers and drivers of vehicles, with reference to monitors in the vehicle. This is especially true for rear passengers in a vehicle, with reference to a seat according to the invention, in comparison with a seat with an ordinary monitor. This again leads to increased customer acceptance of a monitor equipped and arranged according to the invention, in comparison with an ordinary monitor.

The layers in the figures are drawn in the interest of simplicity and clarity and are not necessarily true to scale. For example, the orders of magnitude of some layers are exaggerated relative to other layers, in order to improve understanding of the practical examples of the present invention.

What is claimed is:

1. A seat for a vehicle comprising a seat surface and a monitor arranged on a side of the seat facing away from the seat surface for depiction of freely variable pictures or symbols, the monitor comprising:
an emission layer, containing a light-emitting polymer;
and a transparent carrier layer, made of a flexible material.

2. A seat according to claim 1, wherein the transparent carrier layer consists essentially of flexible plastic.

3. A seat according to claim 1, the emission layer comprising:
a first light-emitting polymer for emission of light of a first color; and
a second light-emitting polymer for emission of light of a second color.

4. A seat according to claim 3, wherein the first light-emitting polymer is arranged next to the second light-emitting polymer.

5. A seat according to claim 1, the emission layer comprising:
a first light-emitting polymer for emission of light of a first color;
a second light-emitting polymer for emission of light of a second color; and
a third light-emitting polymer for emission of light of a third color.

6. A seat according to claim 5, wherein the first light-emitting polymer, the second light-emitting polymer and the third light-emitting polymer are arranged next to each other.

7. A seat according to claim 1, the emission layer comprising:
a spiro compound.

8. A seat according to claim 1, the emission layer comprising:
a Spiro compound according to formula

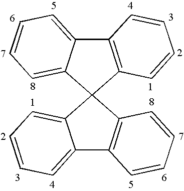

9. A seat according to claim 1, the emission layer comprising:
polyfluorenes.

10. A seat according to claim 1, the emission layer comprising:
polyphenylenevinylenes (PPV).

11. A seat according to claim 1, the emission layer comprising:
R-PPV.

12. A seat according to claim 1, the emission layer comprising:
polyphenylenevinylenes corresponding to the formula

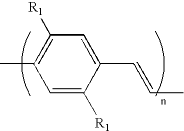

13. A seat according to claim 1, the emission layer comprising:
CN-PPV.

14. A seat according to claim 1, the emission layer comprising
polyphenylenevinylenes corresponding to the formula

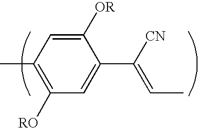

15. A seat according to claim 1, the monitor also comprising:
a number of linear or strip-like front electrodes, arranged between the emission layer and the transparent carrier layer.

16. A seat according to claim 1, the monitor also comprising:
a number of linear or strip-like rear electrodes, arranged on a side of the emission layer facing away from the transparent carrier layer.

17. A seat according to claim 1, the monitor also comprising:
a number of linear or strip-like front electrodes, running essentially parallel to each other, arranged between the emission layer and the transparent carrier layer, and
a number of linear or strip-like rear electrodes, running essentially parallel to each other, arranged on a side of the emission layer facing away from the transparent carrier layer, in which the front electrodes are not arranged parallel to the rear electrodes.

18. A seat according to claim 1, the monitor initially comprising:
a number of linear or strip-like front electrodes, running essentially parallel to each other, arranged between the emission layer and the transparent carrier layer, and
a number of linear or strip-like rear electrodes, running essentially parallel to each other, arranged on the side of the emission layer facing away from the transparent carrier layer, in which the front electrodes are arranged essentially at right angles to the rear electrodes.

19. A seat according to claim 1, wherein the emission layer is a layer applied by means of a inkjet process.

20. Seat according to claim 1, in which a layer of soft material is arranged behind the monitor.

21. A steering wheel for a vehicle with a monitor arranged on a side facing an operator, to depict freely variable images or symbols, the monitor comprising:
an emission layer, containing a light-emitting polymer, and
a transparent carrier layer, made of a flexible material.

22. A steering wheel according to claim 21, wherein the transparent carrier layer consists essentially of flexible plastic.

23. A steering wheel according to claim 21, the emission layer comprising:
a first light-emitting polymer for emission of light of a first color; and
a second light-emitting polymer for emission of light of a second color.

24. A steering wheel according to claim 23, wherein the first light-emitting polymer is arranged next to the second light-emitting polymer.

25. A steering wheel according to claim 21, the emission layer comprising:
a first light-emitting polymer for emission of light of a first color;
a second light-emitting polymer for emission of light of a second color; and
a third light-emitting polymer for emission of light of a third color.

26. A steering wheel according to claim 25, wherein the first light-emitting polymer, the second light-emitting polymer and the third light-emitting polymer are arranged next to each other.

27. A vehicle with a monitor for depiction of freely variable pictures or symbols, the monitor comprising:
an emission layer, containing a light-emitting polymer; and
a transparent carrier layer, made of a flexible material.
